(19) United States
(12) Patent Application Publication
(10) Pub. No.: US 2008/0087308 A1
(43) Pub. Date: Apr. 17, 2008

(54) Parts washer with solvent recycler

(76) Inventors: Mark Ehlman Scuderi, Gaithersburg, MD (US); Albert C. Scuderi, Gaithersburg, MD (US)

Correspondence Address: STEIN, MCEWEN & BUI, LLP, 1400 EYE STREET, NW, SUITE 300, WASHINGTON, DC, 20005, US

(21) Appl. No.: 10/758,047

(22) Filed: Jan. 16, 2004

(51) Int. Cl. B08B 3/04; B08B 3/00

(52) U.S. Cl. 134/111; 134/110; 134/104.2

(57) ABSTRACT

A washing and recycling system for use with removing paint from a coated article. The system includes a basin, a reservoir connected to the basin and which holds a solvent which removes the paint from the coated article, a washing system connected to the reservoir and to the basin such that the solvent from the reservoir is moved past a first filter, and the filtered solvent is moved into the basin so as to remove the paint from the coated article. The system includes a recycling system connected to the reservoir and to the basin such that the solvent from the reservoir is moved past a second filter to remove portions of the paint in the solvent. A control system controls the washing system and the recycling system to supply filtered solvent from the reservoir to the basin during a washing operation and a recycling operation.

### BACKGROUND OF THE INVENTION

1. Field of the Invention

This invention relates to parts washers and, in particular, to parts washers for cleaning paint guns using appropriate solvents.

2. Description of the Related Art

Manual parts washers are well known in the art. Parts washers include a metal cleaning sink associated with a solvent pump for moving solvent through various hoses and outlets in the cleaning sink or basin. Many times, one of the hose has a brush mounted on its end to aid in the removal of adhered dirt, paint, grease or other solids from parts being cleaned. Solvents used are often hazardous and most contain volatile organic compounds (VOCs). The solvent is usually stored in a drum and manually delivered to the parts washer with little to no concern for the safety of the operator or the environment. Solvent recyclers are known, but usually require that the solvent be carried from the washer to the recycling apparatus. Often times, the solvent is merely pumped down the drain or discarded in some other illegal fashion rather than taken to the recycling apparatus.

Using a conventional washer, a pump pulls the solution from the bottom of the sink and pumps the solution to a variety of outlets at the top of the sink for parts cleaning. The washer includes at least a basin for supporting parts to be cleaned, a supply of solvent, a pump for moving the solvent through various hoses and outlets, and control means. U.S. Pat. Nos. 5,323,299, 3,971,394, 5,954,070, 5,349,974, and 6,279,587 are examples of such washers.

### SUMMARY OF THE INVENTION

According an aspect of the invention, an apparatus and method is for cleaning parts, particularly paint spraying equipment, that includes, in one installation, a cleaning station, a rinsing station, and a solvent recycling station.

According an aspect of the invention, zero hazardous waste is produced by using the parts cleaning apparatus.

According an aspect of the invention, the apparatus is easy for personnel to use and makes it quite difficult for the operator to pollute the environment since there are no connections to drains or other public outlets so as to prevent improper release to the environment.

Additional aspects and/or advantages of the invention will be set forth in part in the description which follows and, in part, will be obvious from the description, or may be learned by practice of the invention.

According to an aspect of the invention, a washing and recycling system for use with removing paint from a coated article includes a basin in which the coated article is disposed, a reservoir connected to the basin and which holds a solvent which removes the paint from the coated article, a washing system which is connected to the reservoir and to the basin such that the solvent from the reservoir is moved past a first filter to remove portions of the paint in the solvent, and the filtered solvent is moved into the basin so as to remove the paint from the coated article, a recycling system which is connected to the reservoir and to the basin such that the solvent from the reservoir is moved past a second filter to remove portions of the paint in the solvent, and the filtered solvent is moved into the basin, and a control system which controls the washing system to supply filtered solvent from the reservoir to the basin to remove the paint from the coated article during a washing operation, and which controls the recycling system during a recycling operation to move the solvent from the reservoir to the basin so as to maintain the solvent.

According to an aspect of the invention, the solvent is an aqueous, Hazardous Pollutants (HAPs) free, low VOCs (volatile organic compounds), non-flammable, non-toxic, non-carcinogenic, solvent.

According to an aspect of the invention, the solvent is a biodegradable and water dilutable solvent designed for the removal of residual paints.

According to an aspect of the invention, the control system further includes a pump which selectively moves the solvent from the reservoir through the washing system and the recycling system.

According to an aspect of the invention, the pump is a pneumatic pump that pumps the solvent through the washing system and the recycling system.

According to an aspect of the invention, the basin includes an inlet and a grate disposed above the inlet and a bottom surface of the basin, the reservoir is defined between the bottom surface and the grate, and the pump removes the solvent from the reservoir through the inlet during the washing operation and the recycling operation.

According to an aspect of the invention, the first filter is a dry wound type filter and the second filter is a carbon block type filter.

According to an aspect of the invention, the first filter is other than the second filter such that, during the washing operation, the control system controls the solvent to pass through the first filter but to not pass through the second filter.

According to an aspect of the invention, the first filter is other than the second filter such that, during the recycling operation, the control system controls the solvent to pass through the second filter.

According to an aspect of the invention, the system further includes a gun mount through which the solvent passes during the washing operation and on which a paint gun is mountable so as to remove the paint from the paint gun during the washing operation.

According to an aspect of the invention, the system further includes a cup mount through which the solvent passes during the washing operation and on which a cup from a paint gun is mountable so as to remove the paint from the cup during the washing operation.

According to an aspect of the invention, the system further includes a brush through which the solvent passes during the washing operation so as to clean a coated article.

According to an aspect of the invention, the system further includes an air hose, wherein the control system further controls a supply compressed air passing through the air hose.

According to an aspect of the invention, the first filter and the second filter comprise removable filters.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of the gun cleaning and recycling system according to an embodiment of the invention;

FIG. 2 shows an embodiment of the recycling system used in the gun system and recycling system of FIG. 1; and

FIG. 3 shows an embodiment of the washing system and the gun cleaning system of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to a related device, a washer includes a triple basin sink having a wash basin adjacent a water rinse basin integral with a recycling/filtration basin/sink. An air operated pump draws solution from the bottom of basin through an inlet so that it can be dispersed through the various fluid outlets in the upper half of wash basin. Included are upper and lower outlets/mounts and a spray brush. The fluid outlets/gun mounts can be placed anywhere in the basin for appropriate coverage depending on the parts being washed. One mount nozzle is mounted to the back of the sink. Fluid flows are controlled by the various devices on control panel including several valves for opening and closing the various mounts/outlets as well as a pressure dial and other indicators to allow the operator to watch the function of the system. On/off controls for the pump are available on the control panel as well. A support screen is mounted in the basin to hold parts for cleaning and to allow the solvent to pass through it to the bottom of the basin for pumping back up to the cleaning area. A variety of filters can be placed in any of the hoses and at the inlet to the pump to protect the pump and the various mounts/outlets. After parts are cleaned in the basin, they are generally, although not required to be, transferred to the warm water rinse station. The rinse station includes a parts support much like the support in basin. The parts are rinsed with warm water from spigot and the rinse solution falls to the bottom of the sink where it can be collected through the drain and valve cock, with an optional filter, in the bottom of the sink. Each of the three sinks has a drain with a valve cock at the bottom. The recycling basin includes a filtration insert housing the several filters for filtering the wash solution. Dirty solution from the bottom of sink can be drained through drain/valve cock into a bucket and dumped into the recycling insert. Once the wash solution is poured or pumped into the filtration insert in the recycling basin, a top is placed on the basin. The solution sits in the tank and drains slowly through filters (such as 10″ carbon block filters or ceramic filters) into the bottom of basin. The clean solution is at the bottom of basin after passing through the filters. Tubing connects the drains to two-way valve. The two way valve is connected to pump by tubing and allows the solution from the bottom of basin to be pumped through the pump back up to the cleaning nozzles when positioned to connect drain and to cut off drain. The filters are easily replaceable once their filtering efficiency decreases.

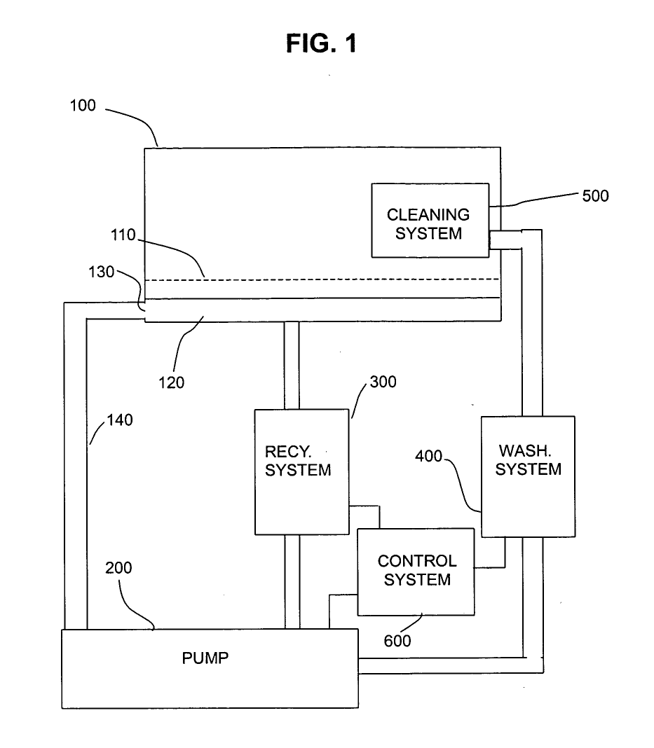

As shown in FIG. 1, the cleaning and recycling system according to an aspect of the invention includes a basin 100 that is connected to a pump 200 through an intake line 140. The pump 200 is connected to a recycling system 300 and a washing system 400, both of which are connected to the basin 100. The washing system 400 is further connected to a gun cleaning system 500 through which fluids pass so as to perform the cleaning function of the system.

During operation, a control system 600 controls the operation of the pump 200, the recycling system 300, and the washing system 400. Within the basin 100 and beneath a screen 110 is a reservoir which holds a fluid 120. The fluid 120 is selectively introduced into the recycling system 300 and the washing system 400 through an intake 130 due to the control system 600 and the pump 200. While the fluid 120 can be any fluid useable to wash items and which can be maintained using the present invention, according to an aspect of the invention, the solvent is an aqueous, Hazardous Pollutants (HAPs) free, low VOCs (volatile organic compounds), non-flammable, non-toxic, non-carcinogenic, solvent which includes non-regulated solvents. The solvent according to an embodiment of the invention further is biodegradable and water dilutable and is designed for the removal of residual paints. An advantage to having the water-soluble solvent is to reduce a fire risk otherwise present when using a lacquer-type solvent.

While not required in all aspects of the invention, the solvent used in an aspect of the present system is the subject of U.S. Pat. No. 5,972,865, the disclosure of which is incorporated herein by reference. According to an aspect of the invention, the solvent is ACRASTRIP 5000, sold by POLYCHEMICAL CORPORATION, to which 50% water was added to form the BONNY MARLIN SOLUTION of 1:1 ACRASTRIP 5000:water.

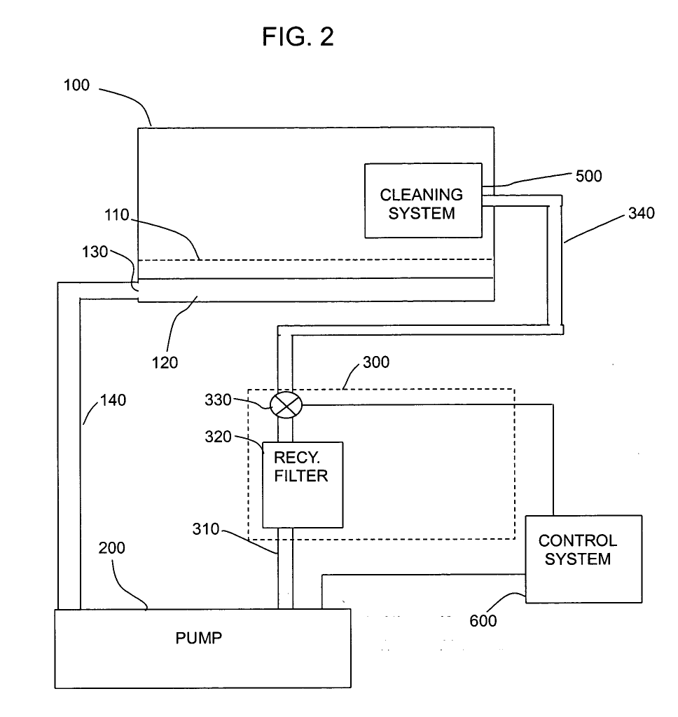

As shown in FIG. 2, an embodiment of the recycling system 300 includes a line 310 which connects the pump 200 to a filter 320. The filter 320 is used for recycling and is generally changed every 3-5 months. In order to control the recycling function, the control system 600 turns on the valve 330 and controls the pump 200 to pump fluid 120 from within the basin 100 through the intake line 140. The pump 200 then pumps the fluid 120 through the line 310 into the recycling filter 320 past the open valve 330 and returns into the basin 100 through outlet 340.

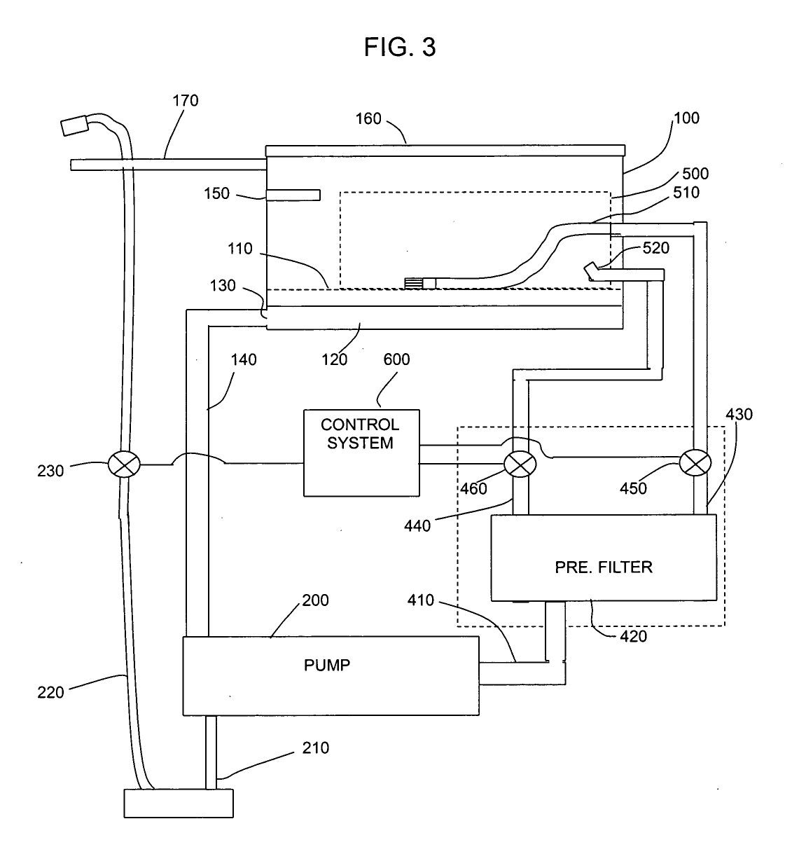

An embodiment of the washing system 400 and the gun cleaning system 500 is shown in FIG. 3. As shown in FIG. 3, the pump 200 is connected to a pre-filter 420. The pre-filter 420 is connected to the gun cleaning system 500 through lines 430 and 440. During a washing operation, the control system 600 controls the pump 200 to pump the fluid 120 through the intake line 140 to the filter 420 through line 410. Where fluid is passed through line 430, a control system opens valve 450 to allow the fluid 120 to pass to the corresponding element in the gun cleaning system 500 (as shown, the element is a brush 510). Where the fluid 120 is to pass through line 440, the control system opens valve 460 to allow the fluid 120 to pass into another element of the gun cleaning system 500 (as shown, the element is a gun mount 520). During the wash cycle, the control system 600 controls the pump 200 to operate and pump fluid 120 through the washing system 400, but does not allow fluid 120 to pass through the recycling system 300. Conversely, during a recycling and maintenance cycle, the control system 600 prevents the fluid 120 from passing through the washing system 400 and instead passes the fluid 120 through the recycling system 300 as shown in FIG. 2.

As shown in FIG. 3, an embodiment of the gun cleaning system 500 includes a brush 510, through which the fluid 120 passes and which is used to clean elements, such as paint guns. The shown embodiment of the gun system 500 also has a mount 520 through which fluid 120 passes and on which a paint gun or cup can be mounted so as to clean the internal workings of the paint gun or cup. The shown mount 520 is a non-atomizing fluid outlet. However, it is understood that additional cleaning elements can be included in the gun cleaning system 500, and that additional brushes 510 and mounts 520 can be used. For instance, the gun cleaning system 500 could include dual gun mounts 520, dual cup mounts 520 and dual brushes 510.

In the shown embodiment in FIG. 3, a shelf 150 is disposed in the basin 100 so as to provide a place on which a cleaned paint gun or paint gun element is allowed to rest. In addition, the basin 100 has a top that is closed by a cover 160. According to an aspect of the invention, the cover 160 is closed during the maintenance cycle and also when the cleaning and recycling system is not being used.

According to an aspect of the invention shown in FIG. 3, a shelf 170 is attached to the basin 100. While not required in all aspects of the invention, the control system 600 can be disposed on the shelf 170. The control system 600 can include multiple control elements for use in controlling the various valves 330, 450, 460, 230 (such as a switch), and can further include an air regulator and air pressure gage for use in controlling the pump 200.

The shown pump in FIG. 3 is a pneumatic pump whereby the power supplied to the pump 200 is introduced through an airline 210. It is understood that other types of pumps 200 can be used, such as electrical pumps or other types of devices which are used to produce differential pressures or otherwise produce fluid flows. However, the shown embodiment of the pneumatic pump 200, such as pumps provided by ARO, allows for use of the system on a typical shop floor or in a lab without requiring a separate electrical hook up. Specifically, the shown system in FIGS. 1-3 uses a pneumatic pump 200 so as to hook up to a compressed air system often found in auto body shops or in labs.

According to the shown embodiment of the invention in FIG. 3, an air hose 220 is further connected to a compressed air source also used for the pump 200. The air hose 220 is controlled by a valve 230 using the control system 600. While shown in FIG. 3, it is understood that the air hose 220 and the valve 230 would not be required in all aspects of the invention, especially where the pump 200 is not a pneumatic pump. While the air hose 220 is held by the shelf 770 in the shown embodiment, it is understood that the air hose 220 need not be connected to the shelf 170. Further, it is understood that the air hose 220 can be separately connected as shown or can be connected through a common air hose line.

In general, while shown as being within a reservoir formed beneath a screen 110, it is understood that the reservoir which holds the fluid 120 need not be separated by the screen 110. As such, the reservoir could be a separate basin connected for use with the recycling and washing systems 300, 400. For instance, a separate basin for housing the fluid 120 could be attached at a bottom of the basin 100 and be separated by a line having the screen 110 therebetween so as to separate paint from the fluid 120 during the washing and/or maintenance cycles while allowing the intake 130 to access the fluid 120 for use in the washing and/or maintenance cycles. Such a reservoir could be removable from the basin 100. Further, it is understood that, since the shown system in FIGS. 1-3 use separate filters 320 and 420, an embodiment of the invention could have a single filter for use both during recycling and washing operations so as to further simplify the gun cleaning and recycling system.

According to an aspect of the invention the paint gun to be cleaned is disassembled. By way of example, a cup (not shown) is unscrewed from the gun body (not shown). A spray nozzle cap (not shown) is also removed from the gun body (not shown). Where the cup is used as part of the paint gun, the cup is mounted to a corresponding mount 520 of the gun cleaning system 500. The spray nozzle cap is disposed in the basin 100 for cleaning. Additionally, the gun body is mounted in the basin 100. Optionally, a trigger clip is applied to the gun body to maintain the trigger in a depressed condition. The gun body is mounted on a corresponding mount 520. The control system 600 is operated so as to start the pump 200, to activate the washing system 400, and to control which of the mounts 520, a brush 510, or other element receives the fluid 120. Fluid 120 is pumped from the reservoir below the screen 110 and into the washing system 400 so as to pump fluid 120 through the gun mounts 520 and the cup mount 520. The fluid 120 is allowed to pass through the cup and the paint gun at a rate controlled by the control system 600 until the paint has been removed from the paint gun, the spray nozzle cap, and the cup.

The fluid 120 has the properties of releasing the paint from the gun and the cup (i.e., cleans and removes any paint remaining on the paint gun). Additional cleaning of the cup and/or the gun can be provided using the brush 510 through which the fluid 120 also passes so as to provide spot cleaning of various elements. Through this process, the paint gun elements are cleaned and any paint residue has been removed through the washing action using the fluid 120. A portion of the removed paint after the washing cycle returns to the reservoir and is removed using the filters 420 and 320. However, for other portions of the paint, such as pigmentation and/or paint sediment/residue, the portion is allowed to settle in the reservoir so as to remove both portions of the paint through filtration and settling.

Where multiple paint gun and/or paint gun elements are to be washed, it is understood that the control system 600 can activate various elements of the gun cleaning system 500, such as additional gun or cup mounts and/or brushes, so as to simultaneously clean multiple paint guns and/or elements contaminated with paint using the washing system 400. Additionally, instead of using one large basin 100 with multiple mounts 520, the basin 100 could be subdivided into smaller basins connected through the reservoir.

While not required in all aspects of the invention, the system of FIGS. 1-3 need not be maintained using the recycling system 300 more than once every 200 gun cleanings or two weeks. During a maintenance cycle according to an aspect of the invention, the solution/fluid 120 is drained into a separate container (not shown). The basin 100 is then wiped out to remove particulates. Where the basin 100 is not to be wiped out, it is understood that the draining of the fluid 120 need not be performed. The solution/fluid 120 is then returned to the basin 100. The pre-filter 420 and an o-ring of the pre-filter 420 are preferably changed at this point, although the pre-filter 420 and/or the o-ring need not be changed during the maintenance in all aspects of the invention.

The control system 600 is changed to the recycling mode whereby the recycling filter 320 is engaged instead of the pre-filter 420. However, it is understood that it is possible to run the recycling of the maintenance process using both the recycling filter 320 and the pre-filter 420. During the maintenance cycle, the fluid 120 is allowed to cycle through the system for a period of roughly 15 minutes. However it is understood that other time lengths can be used as is necessary to maintain the system. The recycling filter 320 is generally only used during the maintenance operation and is generally replaced every 3-5 months. The entire maintenance cycle is estimated to take roughly 25 minutes or so to be performed every 2 weeks.

The specific filter elements can be any filter usable with the fluid 120. According to an aspect of the invention, the filter 320 is a carbon block type filter, and the filter 420 is a dry wound filter, and the filters 320, 420 are removable. However, it is understood that the filters can be other types, such as a dry ash filtrate type or a ceramic candle filter that can be easily disposed of without concern for the environment.

While not shown, a rinse basin is further attached to the basin 100 according to an aspect of the invention. In the rinse basin, water borne paints can be pre-rinsed in the fluid 120 prior to being washed in the basin 100. A settling solution is added in the rinse basin according to a maintenance cycle in order to separate the water borne pigments from the fluid 120 so as to collect the pigments at the bottom of the rinse basin for easy removal. Otherwise, the settling solution could be included in the basin 100 in order to remove pigments contained therein.

The cleaning and recycling system described in relation to FIGS. 1 and 3 in the context of cleaning paint guns can be used in any cleaning operation whereby elements of a system need to have contaminates (such as or analogous to paint) removed and where it is desired to have a recycling system to maintain the cleaning solution that does not produce hazardous waste and/or is not harmful to workers health or the health of the environment. An aspect of the invention has the system as a single unit which provides both cleaning and recycling functions, and which does not require an electrical connection. Moreover, the system is non-toxic, free of hazardous air pollutants, generates no hazardous waste, is non-flammable, is recyclable, and reduces VOC emissions by up to 80%. Moreover, the use of the system reduces both civil and criminal liability for violations of applicable environmental regulations and laws, reduces operating costs, and is helpful in protecting public health environment.

Although a few embodiments of the present invention have been shown and described, it would be appreciated by those skilled in the art that changes may be made in this embodiment without departing from the principles and spirit of the invention, the scope of which is defined in the claims and their equivalents.

1. A washing and recycling system for use with removing paint and related spray coatings from a coated article, comprising:
a basin in which the coated article is disposed;
a reservoir connected to the basin and which holds a solvent which removes the paint and/or the related spray coatings from the coated article;
a washing system which is connected to the reservoir and to the basin such that the solvent from the reservoir is moved past a first filter to remove portions of the paint and/or the related spray coatings in the solvent, and the filtered solvent is moved into the basin so as to remove the paint and/or the related spray coatings from the coated article;
a recycling system which is connected to the reservoir and to the basin such that the solvent from the reservoir is moved past a second filter to remove portions of the paint and/or the related spray coatings in the solvent, and the filtered solvent is moved into the basin; and
a control system which controls the washing system to supply filtered solvent from the reservoir to the basin to remove the paint and/or the related spray coatings from the coated article during a washing operation, and which controls the recycling system during a recycling operation to move the solvent from the reservoir to the basin so as to maintain the solvent.

2. The washing and recycling system of claim 1, wherein the solvent comprises an aqueous, Hazardous Pollutants (HAPs) free, low VOCs (volatile organic compounds), non-flammable, non-toxic, non-carcinogenic, solvent.

3. The washing and recycling system of claim 2, wherein the solvent comprises a biodegradable and water dilutable solvent designed for the removal of residual paints.

4. The washing and recycling system of claim 1, wherein the control system further comprises a pump which selectively moves the solvent from the reservoir through the washing system and the recycling system.

5. The washing and recycling system of claim 4, wherein the pump comprises a pneumatic pump that pumps the solvent through the washing system and the recycling system.

6. The washing and recycling system of claim 4, wherein the basin further comprises an inlet and a grate disposed above the inlet and a bottom surface of the basin, the reservoir is defined between the bottom surface and the grate, and the pump removes the solvent from the reservoir through the inlet during the washing operation and the recycling operation.

7. The washing and recycling system of claim 4, wherein the first filter comprises a wound type filter and the second filter comprises a carbon block type filter.

8. The washing and recycling system of claim 4, wherein the first filter is other than the second filter such that, during the washing operation, the control system controls the solvent to pass through the first filter but to not pass through the second filter.

9. The washing and recycling system of claim 8, wherein the first filter is other than the second filter such that, during the recycling operation, the control system controls the solvent to pass through the second filter.

10. The washing and recycling system of claim 9, wherein the solvent comprises an aqueous, Hazardous Pollutants (HAPs) free, low VOCs (volatile organic compounds), non-flammable, non-toxic, non-carcinogenic, solvent.

11. The washing and recycling system of claim 10, wherein the solvent comprises a biodegradable and water dilutable solvent designed for the removal of residual paints.

12. The washing and recycling system of claim 11, wherein the pump comprises a pneumatic pump that pumps the solvent through the washing system and the recycling system.

13. The washing and recycling system of claim 12, further comprising a gun mount through which the solvent passes during the washing operation and on which a paint gun is mountable so as to remove the paint and/or the related spray coatings from the paint gun during the washing operation.

14. The washing and recycling system of claim 12, further comprising a cup mount through which the solvent passes during the washing operation and on which a cup from a paint gun is mountable so as to remove the paint and/or the related spray coatings from the cup during the washing operation.

15. The washing and recycling system of claim 12, further comprising a brush through which the solvent passes during the washing operation so as to clean a coated article.

16. The washing and recycling system of claim 1, further comprising an air hose, wherein the control system further controls a supply of compressed air passing through the air hose.

17. The washing and recycling system of claim 12, further comprising an air hose, wherein the control system further controls a supply of compressed air passing through the air hose, and the pneumatic pump receives the compressed air from the supply of the compressed air received by the air hose.

18. The washing and recycling system of claim 12, wherein the first filter and the second filter comprise a removable filter.

19. The washing and recycling system of claim 18, wherein the basin further comprises an inlet and a grate disposed above the inlet and a bottom surface of the basin, the reservoir is defined between the bottom surface and the grate, and the pump removes the solvent from the reservoir through the inlet during the washing operation and the recycling operation.

20. The washing and recycling system of claim 1, further comprising a non-atomizing mount through which the solvent passes during the washing operation and on which the coated article is mountable so as to remove the paint from the article during the washing operation.
